(19) United States
(12) Patent Application Publication
(10) Pub. No.: US 2005/0208458 A1
(43) Pub. Date: Sep. 22, 2005

(54) Gaming apparatus including platform

(75) Inventors: Rachael S. Smith, San Francisco, CA (US); Andrew Hartzell, Emeryville, CA (US); Jorge G. Soto, Walnut Creek, CA (US); Aaron Norstad, Walnut Creek, CA (US); Emily McCabe, Duvall, WA (US); Christine Denniston, San Francisco, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: LeapFrog Enterprises, Inc., Emeryville, CA (US)

(21) Appl. No.: 10/966,156

(22) Filed: Oct. 15, 2004

Related U.S. Application Data
(60) Provisional application No. 60/512,421, filed on Oct. 16, 2003.

(51) Int. Cl. G09B 19/00

(52) U.S. Cl. 434/128; 434/317

(57) ABSTRACT

Game apparatuses, systems and methods are provided for interactive play by a user. In preferred embodiments, the game apparatus is comprised of a platform having a surface and a print medium having print elements corresponding to a game, wherein the print medium is capable of being received on the surface of the platform. By positioning the print medium on the platform, the game becomes interactive for the user. The platform includes an array of electrical elements under the surface which are coupled to a processor unit. The processor unit is coupled to a memory device having code which provides for the interactive gaming experience for the user.

### CROSS-REFERENCES TO RELATED APPLICATIONS

This application claims the benefit under 35 USC 119(e) from U.S. Provisional Application Ser. No. 60/512,421, filed Oct. 16, 2003, the full disclosure of which is incorporated herein by reference.

### STATEMENT AS TO RIGHTS TO INVENTIONS MADE UNDER FEDERALLY SPONSORED RESEARCH OR DEVELOPMENT

Not Applicable

### REFERENCE TO A “SEQUENCE LISTING,” A TABLE, OR A COMPUTER PROGRAM LISTING APPENDIX SUBMITTED ON A COMPACT DISK.

Not Applicable

### BACKGROUND OF THE INVENTION

A variety of board games are commercially available which provide a board defining a pathway, a game piece for each player to advance along the pathway, and typically a pair of dice, a spinner and/or one or more sets of cards each containing information which is used in regard to advancing the game pieces along the pathway. Such games are primarily amusement devices.

It is desired to provide a board game which is especially adapted for use by children which is not only fun to play but also performs a major function of teaching young children and testing their knowledge in various academic areas. It is also desired to provide a board game which does not require the ability to read and write, therefore being applicable to very young children, and one which adapts difficulty to the level of the user. It is also desired to provide a board game which is interactive with the user and one which allows different users to interact with the game at the same time. And, it is also desired to provide a board game which is adaptable for use with existing electronic interactive toys which are commercially available. At least some of these objectives, as well as others, are met by the apparatus and methods of the invention described hereinafter.

### BRIEF SUMMARY OF THE INVENTION

The present invention provides game apparatuses, systems and methods for interactive play by a user. In preferred embodiments, the game apparatus is comprised of a platform having a surface and a print medium having print elements corresponding to a game, wherein the print medium is capable of being received on the surface of the platform. By positioning the print medium on the platform, the game becomes interactive for the user. The platform includes an array of electrical elements under the surface which are coupled to a processor unit. The processor unit is coupled to a memory device having code which provides for the interactive gaming experience for the user.

In some embodiments, the game performs the function of teaching young children and testing their knowledge in various academic areas. In these embodiments, the print medium includes a plurality of marker spaces arranged in a path. The user moves a game piece or marker along the path according to the game rules. At least some of the marker spaces are correlated to an activity, such as answering a question related to an academic subject or performing a task. Typically, a predetermined set of subjects are provided and are considered subject categories, such as language arts, math, social studies, life sciences, physical science, geography, science, history, pop culture, sports, and a wild category, to name a few. Questions related to the subject categories may be in a variety of forms, including multiple choice, true-or-false, head-to-head, and double-or-nothing. When a question is answered correctly, the user fulfills the related subject category. In addition, subject categories may be fulfilled by other methods according to the game, such as by “stealing” a subject category. In some embodiments, an object of the game is to be the first player to fulfill all of the subject categories. It may be appreciated that the game apparatus may provide a variety of other games having differing elements, rules, and objectives. However, each embodiment of the present invention includes a variety of features described herein.

In a first aspect of the present invention, a platform is provided including a surface, wherein an array of electrical elements are disposed under the surface and a processor unit is coupled to the array of electrical elements. The array of electrical elements and processor form an electronic position location system in the platform. A memory device is also included in the platform or coupleable with the platform so that the memory device is coupled with the processor. The electronic position location system is used to determine the location of the game pieces or markers, to activate a variety of board buttons, and to monitor a variety of activities related to the game. In some embodiments, a stylus is provided which is used with the electronic position location system to assist in these functions.

In another aspect of the present invention, a print medium having print elements corresponding to a game is provided. Typically the print medium is capable of being received on the surface of the platform, however in some embodiments, the print medium is integral with or printed on the surface of the platform. In some embodiments, the print elements include start blocks, marker spaces, board buttons (such as a pause button, repeat button, rules button, and volume button), and subject categories. The memory device typically includes code for identifying the position of the marker on the marker spaces, for providing the action designated by the board button, or for providing a question related to a subject category, to name a few. In addition, each subject category print elements may also have an associated element, such as a window, the positions of which are used to visually indicate to the players which subject categories have been fulfilled at any time. The memory device may also include code for identifying and tracking fulfillment of the subject categories by the players to effectively keep score throughout the game.

In another aspect of the invention, at least one user activated switch is provided. The user activated switches are removably or fixedly coupled to the platform and are capable of being in electrical communication with the processor. The user activated switches may be coupled to the platform in a variety of ways. For example, the user activated switches may be positioned on the print medium or may be disposed near the end of a tether to allow free movement of the user activated switches. Further, the user activated switches may be coupled directly with the platform or may be coupled with a memory device which is removably coupleable with the platform, such as cartridge which is insertable into the platform. In some embodiments, the user activated switch comprises a pressure switch. The user presses the pressure switch to input a feedback response, such to indicate readiness to answer a question, to select an answer option, to start or end a time period or to request information, such as the number of spaces to move a marker (thus acting as virtual dice or a virtual spinner), to name a few. In preferred embodiments, the memory device includes code for an audio output corresponding to activation of the user activated switch. It may be appreciated that any number of user activated switches may be provided, including one, two, three, four, five or six.

Systems of the present invention may include any combination of the components described herein. For example, a gaming system may include a platform including a surface, a print medium including print elements corresponding to a game having marker spaces, wherein the print medium is capable of being received on the surface, and a marker positionable on the print medium and moveable along the marker spaces. The platform including an array of electrical elements under the surface and a processor unit coupled to the array of electrical elements. The system further including a memory device coupled to the processor. Again, the memory device may includes code for providing a question related to at least one of the marker spaces, such as a multiple choice question, a true-or-false question, a head-to-head question, or a double-or-nothing question, to name a few. Typically, at least one of the marker spaces is correlated to a subject category and the question is related to the subject category. Some systems may also include a stylus connected with the processor, wherein the stylus transmits a signal indicating a position on the print medium. And, preferred systems include one or more user activated switches.

Method are provided for using a game apparatus or gaming system of the present invention. The methods include providing the game apparatus according to the present invention. Further, some methods include registering the position of a marker on the print medium and receiving an auditory output related to the position of the marker. When the game apparatus includes a stylus connected with the processor, registering the position of the marker may comprise transmitting a signal to the processor with the use of the stylus indicating the position of the marker on the print medium. In some embodiments, receiving an auditory output comprises receiving a question. Again, the question may comprise, for example, a multiple choice question, a true-or-false question, a head-to-head question, or a double-or-nothing question. When the game apparatus further comprises a user activated switch coupled to the platform, the user activated switch capable of being in electrical communication with the processor, the method may further comprise activating the user activated switch to answer the question.

Other objects and advantages of the present invention will become apparent from the detailed description to follow, together with the accompanying drawings.

### BRIEF DESCRIPTION OF THE DRAWINGS

FIGS. 1-6 illustrate an interactive print media apparatus having a suitable platform for use in the gaming apparatus according to embodiments of the invention.

FIGS. 7A-7C illustrate an embodiment of a game system used in combination with a platform to form the interactive gaming apparatus of the present invention.

FIG. 8 illustrates positioning of a print medium on a platform.

FIG. 9 illustrates moving of markers around the print medium of FIG. 8.

FIG. 10 illustrates an embodiment of a print medium, having print elements corresponding to a game, positioned on a platform.

FIG. 11 illustrates another embodiment of a print medium having print elements corresponding to a game.

FIGS. 12A-12C illustrate an embodiment of a user activated switch of the present invention.

FIG. 13 illustrates an embodiment of a memory cartridge of the present invention.

FIGS. 14A-14B illustrate two user activated switches electronically and mechanically coupled to a cartridge.

FIGS. 15A-15D illustrate another embodiment of a memory cartridge of the present invention.

FIG. 16A illustrates coupling of the cartridge to the user activated switches by tethers.

FIG. 16B illustrates structural coupling of the memory cartridge with user activated switches.

FIG. 17 illustrates examples of Subject spaces and corresponding subject categories.

FIGS. 18A-18B illustrate a window associated with a subject category in an open position and a closed position.

FIG. 19 illustrates an embodiment of a Chance space.

FIG. 20 illustrates an embodiment of an Act Out space.

FIG. 21 illustrates another embodiment of a print medium of the present invention having print elements corresponding to a game.

### DETAILED DESCRIPTION OF THE INVENTION

In preferred embodiments, the game apparatus is comprised of a platform having a surface and a print medium having print elements corresponding to a game, wherein the print medium is capable of being received on the surface of the platform. By positioning the print medium on the platform, the game becomes interactive for the user. The platform includes an array of electrical elements under the surface which are coupled to a processor unit. The processor unit is coupled to a memory device having code which provides for the interactive gaming experience for the user.

It may be appreciated that the print medium may be capable of being received on the surface of the platform or may be integral with or printed on the platform itself. Having the print medium be removable from the platform allows the platform to be used for other activities, such as learning exercises or other games. However, the apparatus may be dedicated to the specific game by being integral with or printed on the platform itself. The embodiments described herein include a removable print medium having print elements corresponding to a game, however this is simply for illustrative purposes and is not intended to limit the scope of the invention.

Platform

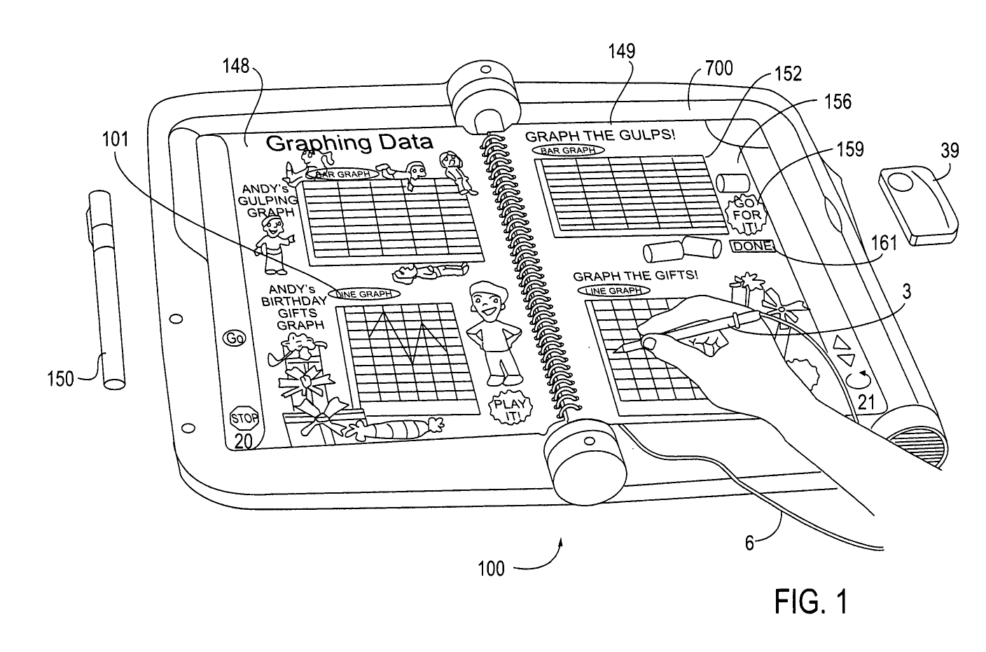

FIGS. 1-6 illustrate an interactive print media apparatus having a suitable platform, the apparatus of which is described in U.S. patent application Ser. No. 10/360,564, filed Feb. 6, 2003. The basic components of the platform and other elements can be used in the gaming apparatus according to embodiments of the invention.

FIG. 1 shows an interactive print media apparatus 100. The interactive print media apparatus 100 includes a platform 700, and a stylus 3 that is mechanically and electronically coupled to the platform 700 via a wire 6, and a memory device 39 in the form of a data cartridge. A print medium 156 is on the platform 700. The memory device 39 can plug into a recess (not shown) in the platform 700.

When it is plugged into the platform 700, the memory device 39 is in communication with an electronic position location system in the platform 700. The memory device 39 may contain code for various audio outputs corresponding to various print elements in the print medium 156. Such audio outputs may include interpretations of print elements, sound effects associated with print elements on a print medium, etc.

In this example, the memory device 39 is in the form of a data cartridge that is external to the platform 700. The memory device could also be internal to the platform in other embodiments. For example, the memory device may comprise any suitable combination of internal or external ROM (read only memory) units, EEPROM (electronically erasable programmable read only memory) units, PROM (programmable read only memory) units, etc. The memory device may be in the other forms (e.g., a memory stick, CD-ROM, etc.).

In some embodiments a writing instrument 150 may be provided for use with the print media apparatus 10. The writing instrument 150 is preferably an erasable marker with erasable ink. Erasable ink that is marked on the print medium 156 can be removed with, for example, a brush or a cloth. The writing instrument 150 could alternatively be a pencil, a pen, or crayon. In the illustrated embodiment, the writing instrument 150 comprises an erasable marker with a cap having an erasing element (e.g., a sponge or a brush). The writing instrument 150 may be held in a holder (not shown) that is connected to the platform 700.

When the print medium 156 is an erasable print medium, the user can write on the sheets of the print medium 156 and can later erase any markings made on the sheets of the print medium 156 so that they can be re-used. The erasable print medium 156 may comprise one or more sheets of paper, each of which is sealed with a polymeric material (an acetate material or Mylar™), or may comprise plastic sheets without paper. In another embodiment, a normal sheet of paper may be used in combination with an erasable pencil.

In some embodiments, the print medium 156 may comprise a transparent sheet (e.g., made of acetate or Mylar™) that may be layered over a sheet having graphics or other printing on it. For example, an acetate or Mylar™ sheet, or other transparent material, could be bound at one edge, say a top edge, to the back cover of the book and flipped over another page with print elements. The user can see the print elements through the transparent sheet. Alternatively, a loose transparent sheet could be inserted in the binding in front of any page having an image where the user is expected to write.

A print medium 156 in the form of a book is shown in FIG. 1. However, any suitable print medium can be used. For example, in embodiments of the invention, the print medium can comprise plastic, paper, cardboard, etc., and can be colored or uncolored. The print medium can be a single sheet (e.g., like a worksheet or photograph) or a book. The book can have any suitable number of pages, and may include a binder such as a spiral or a ring binder. Each sheet (e.g., in a book) may also have any suitable size. For example, each sheet can have a standard size such as 5×7, 8.5×11, 8×14, or A4.

Any suitable number or types of print elements can be on the one or more sheets of the print medium. Exemplary print elements include drawings and portions thereof, words, phrases, portions of words, phonograms, shapes, pictures (e.g., photographs) and portions thereof, characters, symbols, maps, letters, numbers, shapes, drawings, blanks, boxes, lines, arrays of indicia (e.g., an array of letters, numbers, or both) etc. Print elements such as blanks, boxes and lines that are at prescribed locations and that are designed to show where the user is supposed to write may be referred to as “write on print elements”.

In some embodiments, the print medium is a book and a left page of the book may have instructional material while the right page may have prescribed locations where a user can write. For example, in FIG. 1, the print medium 156 has two open pages, a left page 148 and a right page 149. The left page 148 has a number of print elements that teach a user about graphs. A user may use the stylus 3 to select any of the print elements on the left page 148 to produce audio outputs that are related to the print elements. For example, after selecting the print element 101 entitled “line graph” with the stylus 3, an audio output such as “a line graph connects points to show how something changes over time” may be produced by a speaker in the platform 700. The right page 149 has prescribed locations 152 where a user can write with the writing instrument 150. Print elements in the form of printed boxes are at the prescribed location 152. In this particular example, after selecting a print element 159 with the phrase “Go for it!”, an audio output from a speaker in the platform 700 can prompt a user to fill in the boxes with the number of “gulps” that the user hears. The user then uses the writing instrument 150 to fill in the boxes according to the number of gulps heard and subsequently creates a number of bar graphs. After the user has filled in the boxes at the prescribed location 152, the user selects the print element 161 that says “Done!” using the stylus 3. An audio output from a speaker in the platform 700 then tells the user how may “gulps” should have been filled into the boxes at the prescribed location 152. The user then listens to the answer and compares it to what was written. In this way, the audio output helps the user interpret what was written.

As shown above, the print medium 156 and the outputs that are stored as code in the memory device 39 can teach a user about one or more subjects at one or more skill levels. Accordingly, some embodiments of the invention are directed to kits that contain print media and memory devices that can be used with the described interactive platforms. For example, a “kit” may comprise a print medium and may also include a corresponding memory device with code for audio outputs that correspond to the print medium. The print medium may have pages with prescribed locations where a user can write.

An output device (not shown) can be in the platform 700 and is also operationally coupled to the electronic position location system. The output device can be an audio output device such as a speaker or an earphone jack. The output device could alternatively be a visual output device such as a display screen.

The platform 700 can have a surface on which the print medium 156 is placed. The platform may house parts of the electronic position location system. The system may include a processor and array of electrical elements (not shown) that are underneath the surface of the platform. The electrical elements can be antennas such as those described in U.S. Pat. No. 5,877,458 or 5,686,705, and U.S. patent application Ser. Nos. 09/574,599 and 60/200,725. All of these patents and patent applications are incorporated herein by reference in their entirety for all purposes. The antennas can transmit signals that can be received by the stylus 3. The stylus 3 can have a receiving antenna (this may be part of the system). When the stylus 2 is over the surface, the stylus 3 receives a particular signal that is associated with the electrical element underneath the stylus 3. Then, the position of the stylus 3 relative to the surface can be determined. The stylus 3 could be used to interact with the various print elements on the print medium that is on the platform 700. The electrical elements may be transmitting antennas that regularly transmit signals that are received by the stylus 3, or may be receiving antennas that receive a signal from the stylus 3.

Electrical elements that are transmitting antennas are described in detail. However, in other embodiments, pressure sensitive switches could be used. Apparatuses with pressure sensitive switches are described in U.S. patent application Ser. No. 09/886,401, filed on Jun. 20, 2001, which is herein incorporated by reference in its entirety.

Some or all of the electrical elements in the array of electrical elements can be pre assigned to retrieve and provide specific outputs for the user so that a user receives a particular output when selecting a print element that is located over a particular electrical element. In addition, some of the electrical elements can be pre-assigned to indicate that a different sheet with different print elements is on the base unit when they are activated. For example, once an electrical element underneath a “Go” circle on a sheet is activated, the electronics in the platform 700 can determine which page of a multi-page print medium is being displayed to the user. A processor can reprogram the interactive apparatus so that the electrical elements in the array are re assigned to retrieve outputs associated with the print elements in the new sheet.

Some components of a preferred interactive print media apparatus are shown in FIGS. 2-6. Other features of a suitable apparatus is described in U.S. patent application Ser. No. 09/777,262, filed on Feb. 5, 2001, which is herein incorporated by reference for all purposes. FIGS. 2 and 3 show a platform with first and second housing portions 1, 2 in open and closed configurations. A pair of hinges 7 connects the first and second housing portions 1, 2 of the platform. A spring-loaded latch 8 holds the housing portions 1, 2 together when closed. Both the first housing portion 1 and the second housing portion 2 comprise an upper section 9, 10 and a lower section 11, 12. The upper sections 9, 10 of the first and second housings 1, 2 are fixed to their respective lower sections 11, 12 with screws 13.

The upper and lower sections 9, 11 of the first housing portion 1 define a cavity within which is provided a first transmitting antenna element (not shown). The upper and lower sections 10, 12 of the second housing 2 also define a cavity. The second housing portion 2 can house a loudspeaker and processor.

The upper surface of the upper section 9 of the first housing portion 1 has a rectangular recess 20. An identical rectangular recess 22 is provided on the upper surface of the upper section 10 of the second housing portion 2. These rectangular recesses 20, 22 lie adjacent to one another with the long sides of the rectangular recesses being separated by a small gap 23. Together the rectangular recesses 20, 22 provide a surface on which a book having, for example, a spiral binding (not shown) can rest. Transmitting first antenna elements are located immediately beneath these rectangular recesses 20, 22. Provided along the edges of the rectangular recesses 20, 22 remote from the gap 23 are thumb grooves 25, 26. The thumb grooves 25, 26 provide means by which a user is able to access the corners of pages of a book resting on the rectangular recesses 20, 22.

Adjacent to the thumb grooves 25, 26 further along the long sides of the rectangular recesses 20, 22 are a pair of stylus rests 27, 28. These stylus rests 27, 28 are arranged to receive a detection stylus 3. Lying in the stylus rest 28 in the upper section 10 of the second housing portion 2 is a detection stylus 3. The detection stylus 3 is connected via a wire 6 to the processor located within the part of the cavity defined by the second housing 2.

Provided in the upper section 10 of the second housing 2 is a loudspeaker grill 35, which is provided immediately above the loudspeaker, housed within the cavity. This loudspeaker grill 35 is provided at the corner of the upper section 10 of the second housing 2 next to the thumb groove 26.

In the portion of the upper section 10 of the second housing 2 adjacent to the stylus rest 28 there is an ON/OFF button 5. The ON/OFF button 5 is connected to the processor within the second housing portion 2 and provides means for activating the processor and the transmitting first antenna elements within the platform unit.

The second housing portion 2 includes a headphone jack 37 and a slot 38 arranged to receive a memory device 39 in the form of a cartridge. Provided within the slot 38 is a mating interface (not shown in FIGS. 3 and 4) for receiving the cartridge. By inserting the cartridge into the slot 38, the cartridge fits into the mating interface. The processor in the second housing portion 2 can access data in the cartridge.

FIG. 4(a) is an exploded view of the platform unit. The processor 60 is connected to the loudspeaker 61, the ON/OFF button 5 and the headphone jack 37 and via the wire 6 to the detection stylus 3. Further the processor 60 is connected to a mating interface 62 for receiving a cartridge 39 and a set of batteries 63 for powering the processor 60.

Two first antenna elements 64, 66 are connected via cables 67 to the processor 60 enabling the processor 60 to control the timing of signals generated by the first transmitting antenna elements 64, 66. The first antenna elements 64, 66 are provided directly beneath rectangular recesses 20, 22. They are sandwiched between the underside of the upper sections 9, 10 of the first and second housings 1, 2 defining the rectangular recesses 20, 22 and sheets of cardboard 68, 70. They rest upon supports 72, 74 on the inside surfaces of the lower sections 11, 12 of the first and second housing portions 1, 2.

Referring to FIG. 4(b), each first antenna element 64, 66 comprises an upper antenna 80 and a lower antenna 82 separated by an insulating acetate sheet 83. The upper antenna 80 comprises a resistive strip 84 formed by printed conductive ink, that extends along one of the short sides of a rectangle corresponding to the area defined by the rectangular recess 20, 22 beneath which the first antenna element is located. Extending away from the resistive strip 84 at right angles to the resistive strip 84 is a plurality of conductive fingers 85 also comprising printed conductive ink. These conductive fingers 85 are spaced equidistantly from one another along the length of the resistive strip 84 and run parallel to one another. The conductive fingers 85 extend from the resistive strip to a length corresponding to the extent of the long side of the rectangular recesses 20, 22.

The lower antenna 82 is disposed on the opposite side of the insulating acetate sheet 83 and comprises a second resistive strip 86. This second resistive strip 86 extends along the periphery of the area along the long side defined by the rectangular recesses 20, 22 beneath which the antenna is located. In a similar arrangement to the arrangement of the upper antenna 80, extending away at right angles from the resistive strip 86 of the lower antenna 82 are a plurality of conductive fingers 87 spaced equidistant from one another along the length of the conductive strip 86. The number of conductive fingers 85, 87 can vary depending on the desired resolution.

The conductive fingers 85, 87 of the second antenna arrangement 66 within the second housing portion 2 form an orthogonal lattice of equally spaced conductive fingers 85, 87 that extends across the entirety of the area defined by the rectangular recess 22 in the upper section 10 of the second housing portion 2 with conductive strips 84, 86 extending beyond the periphery of this area. Similarly, the conductive fingers 85, 87 of the first antenna element 64 within the first housing portion 1 define an orthogonal lattice of equally spaced conductive fingers 85, 87 extending beneath the extent of the rectangular recess 20 in the upper section 11 of the first housing portion 1. These orthogonal lattices of conductive fingers 85, 87 are used to generate electromagnetic fields in the vicinity of the surface of the recesses 20, 22 which can be detected by the detection stylus 3. They are used to determine which portions of a two-dimensional book in the rectangular recesses 20, 22 has been selected utilizing the detection stylus 3.

FIG. 4(c) is a detailed plan view of a first antenna element 66. FIG. 4(c) shows the shape of the conductive fingers 85, 87 of the first antenna element 66. When the conductive fingers 85 extend away from the conductive strip 84 of the upper antenna 80, each of the conductive fingers 85 is identical to one another and comprises a substantially rectangular strip, which has narrower portions 90 wherever the conductive finger 85 overlies one of the conductive fingers 87 of the lower antenna 82. Each conductive finger 87 of the lower antenna 82 includes a rectangular strip with wing portions 92 where the conductive finger 87 is not covered by the conductive fingers 85 of the upper antenna 80.

Provided at either end of the resistive strip 84 of the upper antenna 80 are first 93 and second 94 electrical contacts that are connected via conductive wiring 95 to an interface 96 and hence via the cable 67 to the processor 60. Similar first 97 and second 98 electrical contacts are provided at either end of the resistive strip 86 of the lower antenna 82. These contacts 97, 98 are also connected via conductive wiring 99 to the interface 96, hence via the cable 67 to the processor 60. As in the case of the upper 80 and lower 82 antennas these electrical contacts 93, 94, 97, 98 and the conductive wiring 95, 99 also comprise conductive ink printed on the surface of the acetate sheet 83.

The electrical contacts 93, 94, 97, 98 and conductive wiring 95, 99 enable electrical signals to be applied to the resistive strips 84, 86. When alternating signals are applied to the resistive strips 84, 86 this causes the conductive fingers 85, 87 connected to the resistive strips 84, 85 to generate an alternating electromagnetic field, which can be detected by the detection stylus 3. The resistive strips 84, 86 may comprise a voltage divider strip that allows signals of different voltages to transmit from each of the conductive fingers 85, 87. Further details about the voltage divider strip are in U.S. patent application Ser. No. 09/574,499, filed May 19, 2000. In this U.S. Patent Application, the voltage divider strip includes a number of resistors in series. These resistors allow the conductive fingers 85, 87 to transmit signals of different voltages. Of course, other types of antenna systems may be used. For example, other embodiments that use capacitive division are described in U.S. patent application Ser. No. 10/222,205, filed on Aug. 16, 2002.

FIG. 5 is a schematic cross section of the detection stylus 3 in use detecting an electromagnetic field generated by the first antenna element 66. The detection stylus 3 is shown resting on the surface of the page of a book 4 that lies within the recess 22 in the upper section 10 of the second housing 2. Immediately beneath the upper section 10 of the second housing 2 lie the conducting fingers 85 of the upper antenna 80 of the first antenna element 66. These conductive fingers 85 are provided above the acetate insulating sheet 83 that separates the upper antenna 80 from the lower antenna 82. Disposed on the opposite side of the acetate sheet 83 are the conductive fingers 87 of the lower antenna 82. Beneath the lower antenna 82 lies the protective sheet of card 70 that it supported by the supports 74 of the lower section 12 of the second housing 2.

The distal end of the detection stylus 3 includes a brass ferule 108 that is connected via a solder bead 110 to a copper wire 102, which is connected via wire 6 to the processor 60. Provided at the end of the brass ferule 108 remote from the solder bead 110 is an insulating washer 104. The copper wire 102 extends through the center of this insulating washer 104. Shielding 105 extends within the detection stylus 3, the extent of the copper wire 102 to the insulating washer 104.

Referring to FIGS. 4(a)-4(c) and 5, alternating electric signals are applied via the electrical contacts 93, 94, 97, 98 to the resistive strips 84, 86 of the upper and lower antennas 80, 82. This causes an alternating electromagnetic field to be generated in the vicinity of the antennas 80, 82. This alternating electromagnetic field induces a voltage on the brass ferule 108 of the detection stylus 3 when the detection stylus 3 rests on the surface of a book 4 within the recess 22 adjacent to the antennas 80, 82. This electric signal is then passed via the wire 102 to the processor 60. The insulating washer 104 and shielding 105 prevent electrical signals from being induced within the wire 102 other than by variations in the electromagnetic field in the vicinity of the brass ferrule 108.

FIG. 6 is a schematic block diagram of the processor 60 and the first antenna elements 64, 66. The processor 60 comprises a controller unit 120, transmitter logic 121 and a receiver unit 122. The processor 60 may include a signal driver and a signal processor. The controller unit 120 is connected via the transmitter logic 121 to the first antenna elements 64, 66. The controller unit 120 is also connected via the receiver unit 122 via the wire 6 to the detection stylus 3. The transmitter logic 121 and receiver unit 122 are also connected to each other directly. The controller unit 120 is also connected to the headphone jack 37, the loudspeaker 61, the cartridge mating interface 62 and the ON/OFF button 5.

When the ON/OFF button 5 is pressed, this is detected by the controller unit 120 which causes the transmitter logic 121 to be activated. The transmitter logic 121 then applies electric signals to the electrical contacts 93, 94, 97, 98 of the first antenna elements 64, 66 in a sequence of frames. Referring to FIG. 4(c), in these frames, each lasting approximately 3 milliseconds, predetermined electrical signals are applied to the contacts 93, 94, 97, 98 of the transmitting antenna arrangements 62, 64. At the end of each frame a different set of signals are then applied to the contacts 93, 94, 97, 98.

In the course of a frame, an electromagnetic field is generated in the vicinity of the rectangular recesses 20, 22 in the upper sections 9, 10 in the first and second housing portions 1, 2. These electromagnetic fields induce voltage potentials in the brass ferule 108 of detection stylus 3. This signal is then passed via the wire 6 to the receiver unit 122. In one example, the voltages applied to the contacts 93, 94, 97, 98 may range between plus three volts and minus three volts. The voltage induced within the brass ferule 108 can be about 0.5 millivolts. The receiver unit 122 then processes the induced voltage and a processed signal is then passed to the controller unit 120.

The controller unit 120 then converts the processed signals received from the receiver unit 122 into signals identifying the coordinates of the portion of the page of the book 4 at which the detection stylus 3 is currently located. These coordinates are then used to select an appropriate sound stored within a sound memory either provided as part of the controller unit 120 or alternatively a sound memory provided as a memory chip within a memory device 39, such as a cartridge, inserted within the cartridge interface 62. The appropriate sound is then output via the loudspeaker 61 or to a set of headphones via the headphone jack 37.

Other suitable gaming apparatuses may include a platform, with or without an interactive stylus. Suitable platforms are described in U.S. Pat. Nos. 5,575,659, 5,686,705, and 5,877,458, and U.S. patent application Ser. Nos. 09/574,599, 60/200,725, and 09/886,399. All of these patents and patent applications are incorporated herein by reference in their entirety. Suitable print media receiving units include the LeapPad® Learning Systems line of products made by LeapFrog Enterprises, Inc. of Emeryville, Calif.

Game System

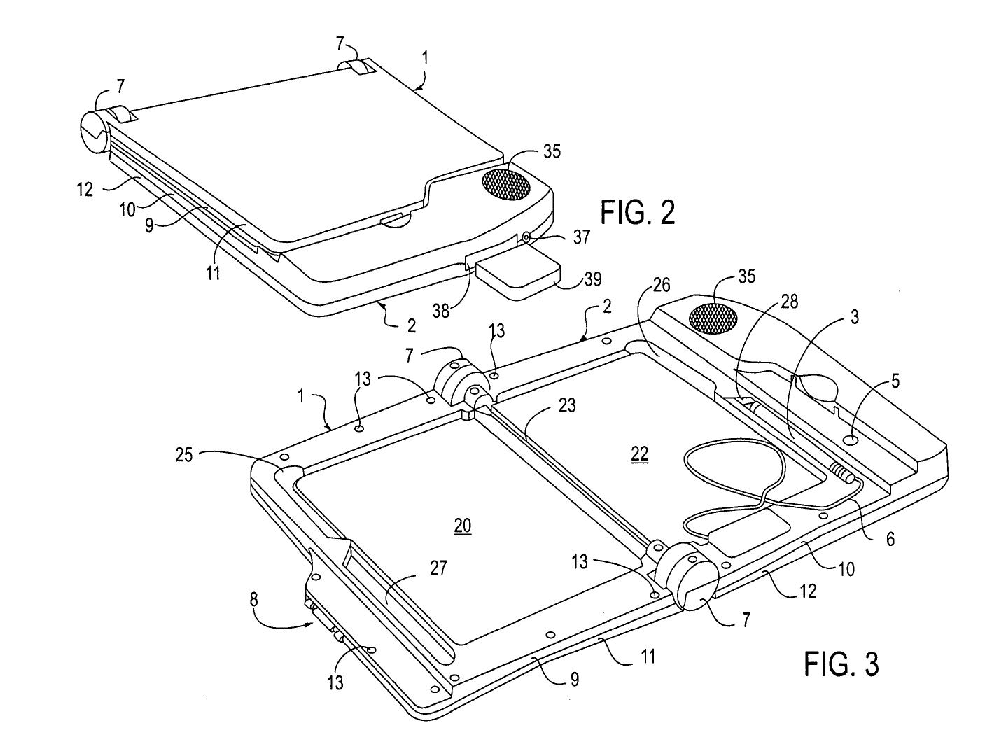

Embodiments of the above described platform are used in combination with a game system to form the interactive game apparatus of the present invention. FIGS. 7A-7C illustrate an embodiment of the game system including a game board or print medium 200 having print elements 202 corresponding to a game (FIG. 7A), game pieces or markers 204 (FIG. 7B), and an electrical device 212 comprised of a pair of boppers, buzzers, input devices or user activated switches 206 coupled to a memory cartridge 208 (FIG. 7C). In this embodiment, the user activated switches 206 are comprised of pressure switches 207 which are operable by pressing with a hand or finger. It may be appreciated that the game system of may be comprised of, for example, the print medium 200 and the markers 204 or the print medium and the electrical device 212. Or, the game system may include user activated switches 206 which are coupled to the print medium 200. A variety of combinations are possible.

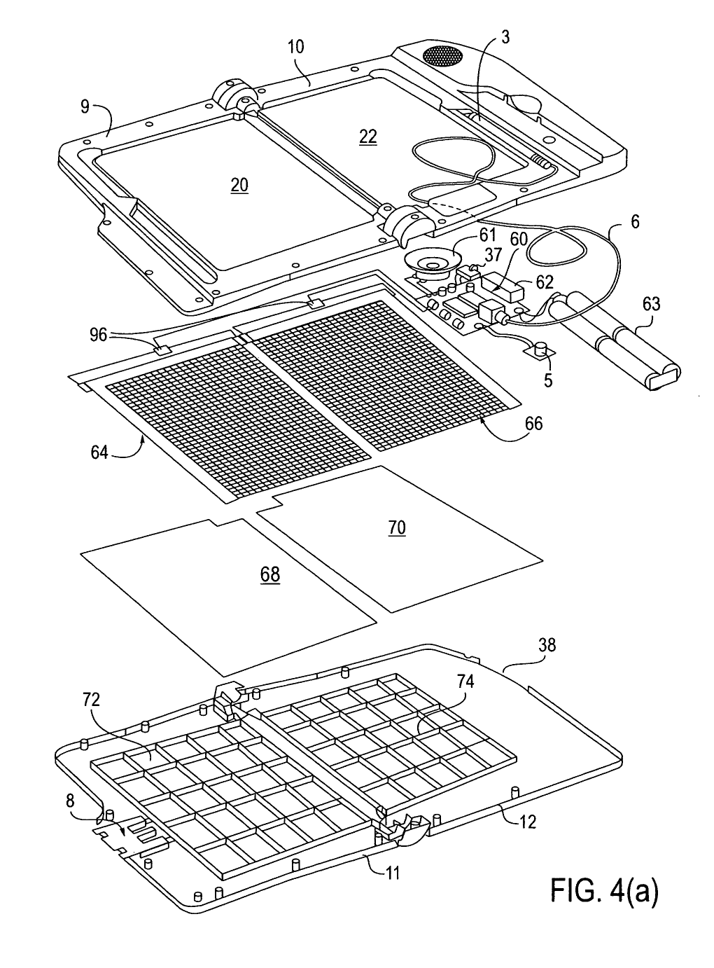

In some embodiments, the print medium 200 has the form of a rigid board 210 that is positionable on a platform 700 as illustrated in FIG. 8. Here, the platform 700 is foldable in half by the action of hinges 7 to allow for storage of the platform 700. The hinges 7 connect the first and second housing portions 1, 2 of the platform. As described above, the upper surface of the upper section 9 of the first housing portion 1 has a rectangular recess 20. An identical rectangular recess 22 is provided on the upper surface of the upper section 10 of the second housing portion 2. These rectangular recesses 20, 22 lie adjacent to one another with the long sides of the rectangular recesses being separated by a small gap 23. Together the rectangular recesses 20, 22 provide a surface on which a print medium 200 can rest. The rigid board 210 is positionable over the opened platform 700 so that the board 210 extends across the rectangular recesses 20, 22 and the gap 23 creating a firm, uniform surface for play. Transmitting first antenna elements are located immediately beneath the rectangular recesses 20, 22 and are accessible through the print medium 200 positioned thereon.

Provided along the edges of the rectangular recesses 20, 22 remote from the gap 23 are thumb grooves 25, 26. The thumb grooves 25, 26 provide means by which a user is able to access the corners of pages of a print medium 200 resting on the rectangular recesses 20, 22. The board 210 may be comprised of any suitable material, typically a rigid plastic or cardboard. The board 210 has dimensions of approximately 9 inches by 12.5 inches, however the board may have any suitable size, typically corresponding to the size of the platform 700. In addition, the board 210 may have any suitable thickness, typically ranging from 1/16- 5/16 inches. In some embodiments, the print elements 202 are disposed on raised surfaces of the board 210 so that the print medium 200 has a three dimensional surface.

The raised, three-dimensional surface may be formed using a plastic molded material. In some embodiments, there can be metal or any other signal bridging material inside of the plastic molded material. This metal can be used to bridge the signal passing between the above described stylus 3 and the above described electronics in the platform 700. Likewise, the above described markers 204 could also include metal so that the user could touch the markers 204 with the above-described stylus 3. The signal between the electronics in the platform 700 and the stylus 3 could thus be bridged by metal in the markers 204 and also in the molded material. Providing signal bridging conductors in three-dimensional structures is described in U.S. patent application Ser. No. 10/174,523, filed on Jun. 17, 2002, which is herein incorporated by reference in its entirety for all purposes. It may also be appreciated that bridging of the signal may occur with solid plastic having no metal. In any case, the absence of air pockets between the surface and the platform is desired.

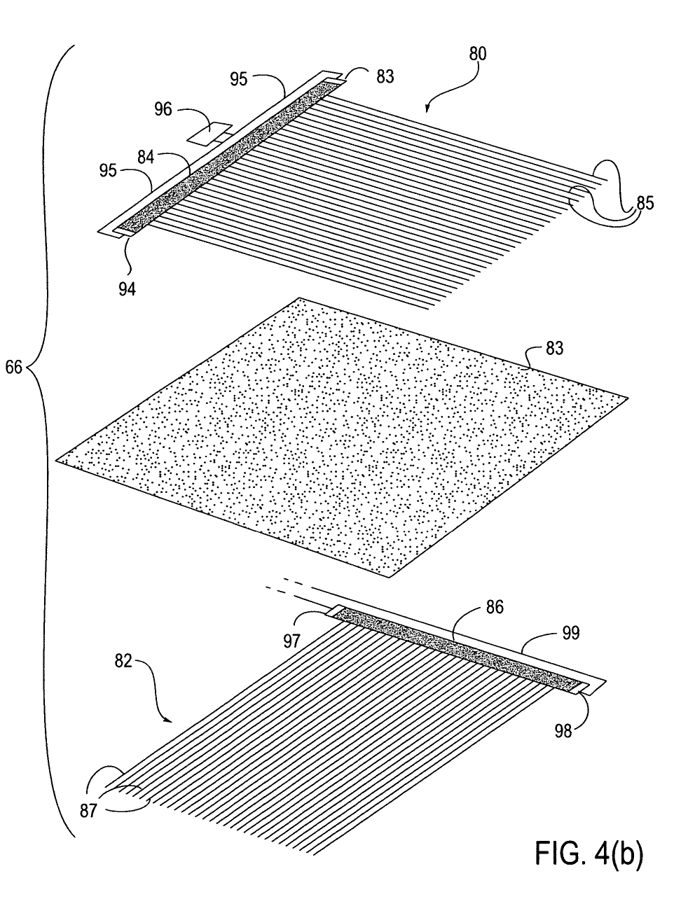

Some surfaces of the board 210 may include holes or indentations 216 which help secure a marker 204 thereon. Referring back to FIG. 7B, an embodiment of one style of marker 204 is shown, each marker 204 having a decorative handle 218 and a protruding tip 220. The protruding tips 220 are sized and shaped to fit into the indentations 216 on the board 210 to hold the marker 204 in place. Thus, users are able to move markers 204 around the board 210, as illustrated in FIG. 9, by holding the handle 218 and inserting the tip 220 into an indentation 216. The marker 204 may then be left in place, extending perpendicularly from the board 210 to mark the user's position on the board 218.

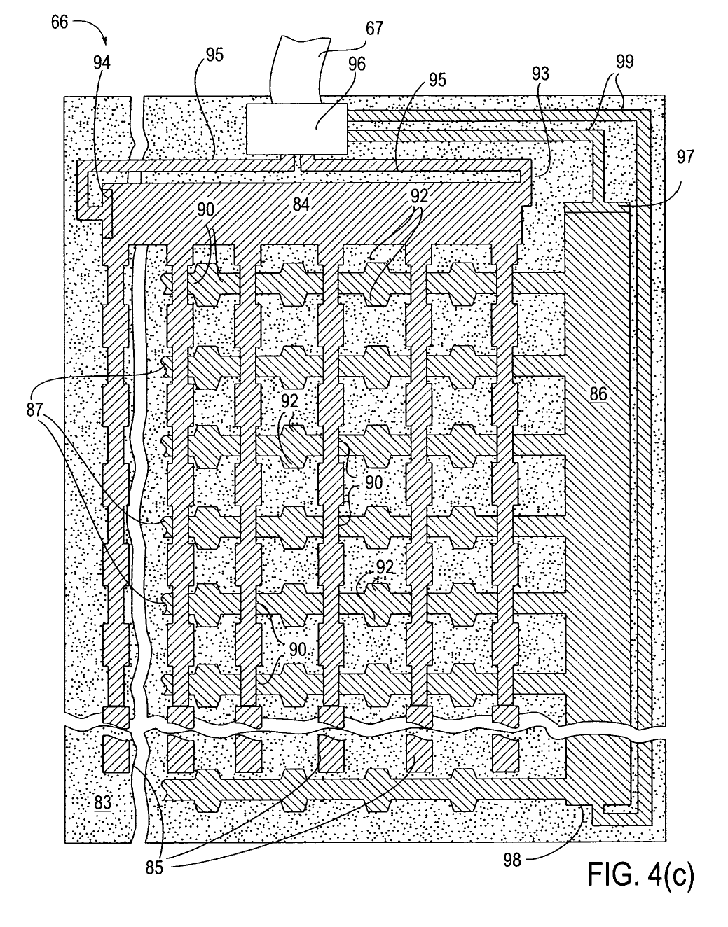

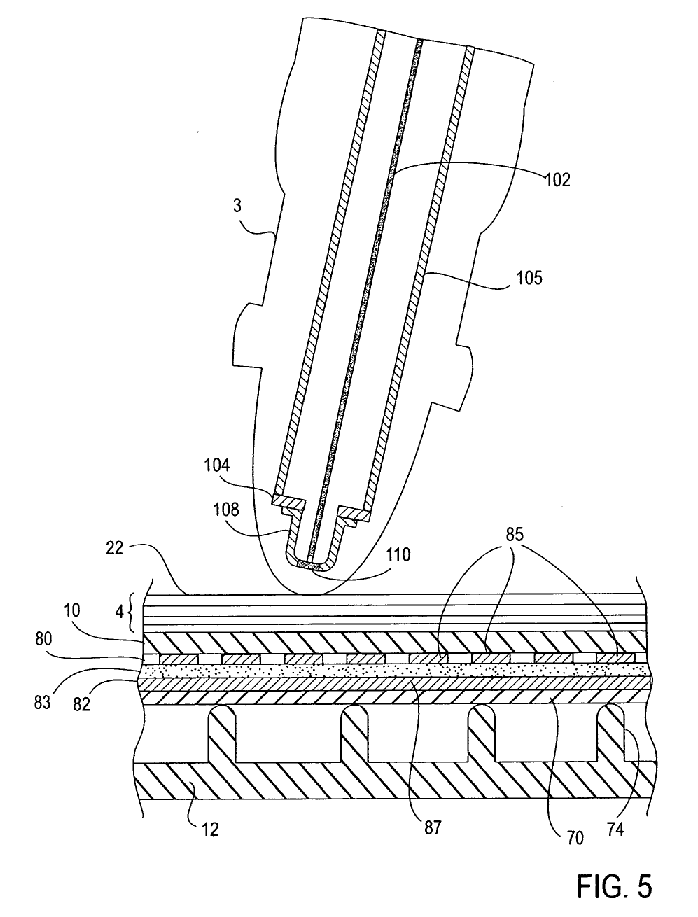

FIG. 10 illustrates an embodiment of print medium 200, having print elements 202 corresponding to a game, positioned on a platform 700 as described above. Here, the print elements 202 include start blocks 280, marker spaces 282, board buttons (such as a pause button 284, repeat button 286, rules button 288, and volume button 290), and subject categories 292. The marker spaces 282 are arranged to resemble a wheel shape, however the spaces 282 may have any suitable arrangement. Similarly, FIG. 11 illustrates another embodiment of a print medium 200 having print elements 202 corresponding to a game. Here, the print elements 202 include marker spaces 282 and subject categories 292, and again the marker spaces 282 are arranged to resemble a wheel shape. Such a wheel shape facilitates variety of paths throughout the marker spaces 282 however many other patterns of marker spaces 282 may also be suitable.

It may be appreciated that the print medium 200 having print elements 202 corresponding to a game may have forms other than a rigid board 210. For example, the print medium 200 may have the form of a sheet of paper or flexible plastic that is positionable over the opened platform 700 so that the medium 200 extends across the rectangular recesses 20, 22 and the gap 23. The sheet may bend or fold at the gap 23 for storage within the platform 700 or separately. Alternatively, the print medium 200 may have the form of a book or booklet having a spiral or other binding so that the binding would lay along the gap 23. The print elements 202 corresponding to the game may extend across the print medium 200 straddling the binding.

Referring back to FIG. 10, an electrical device 212 comprising a pair of user activated switches 206, having pressure switches 207, coupled to a memory cartridge 208 are shown, wherein the cartridge 208 is inserted into a recess in the platform 700. The memory cartridge 208 functions similarly to the memory device 39 of FIG. 1. When the cartridge 208 is plugged into the platform 700, the cartridge 208 is in communication with an electronic position location system in the platform 700. The cartridge 208 may contain code for various audio outputs corresponding to various print elements 202 in the print medium 200 and/or activation of the pressure switches 207. Again, in this example, the cartridge 208 is in the form of a data cartridge that is external to the platform 700. The memory device could also be internal to the platform in other embodiments. For example, the memory device may comprise any suitable combination of internal or external ROM (read only memory) units, EEPROM (electronically erasable programmable read only memory) units, PROM (programmable read only memory) units, etc. The memory device may be in the other forms (e.g., a memory stick, CD-ROM, etc.). However, by having the user activated switches 206 attached to an external memory cartridge 208 that is coupleable with the platform 700, the cartridge 208 may be coupled with a variety of platforms to turn the original platform into a game which utilizes user activated switches 206. Thus, a platform 700 which may not have been specifically designed for playing games using, for example, user activated switches 206, can be easily modified using embodiments of the invention, such as electrical device 212, so that such games can be played using the platform 700.

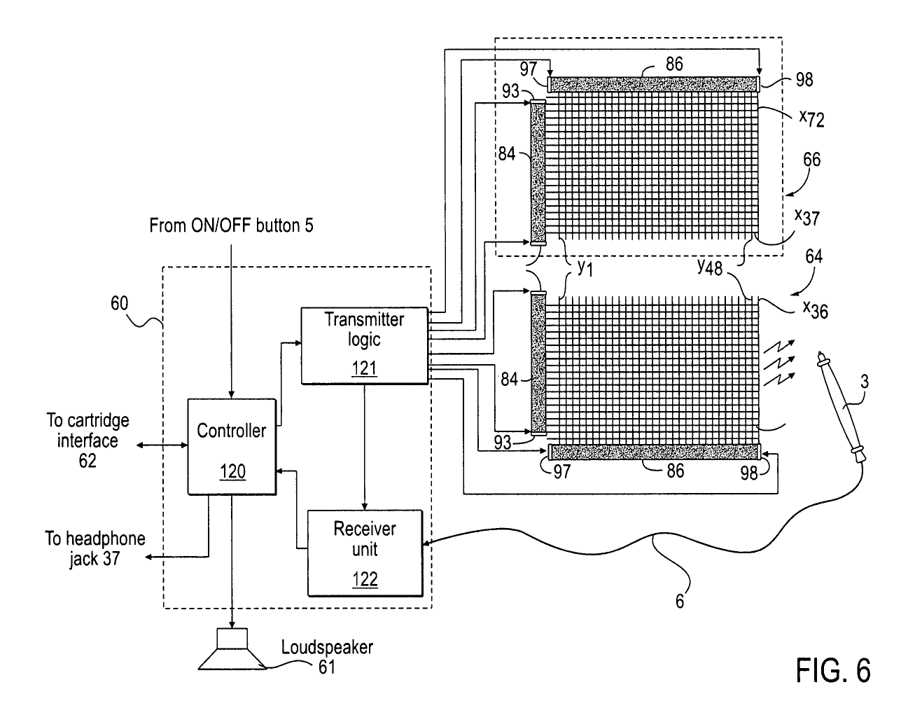

FIGS. 12A-12C illustrate an embodiment of a user activated switch 206 of the present invention. Here, the switch 206 has an oval shape with an approximate width of about 2.49 inches and a length of about 3.27 inches. FIG. 12A provides a top view showing a main pressure switch 230 along with three secondary pressure switches 232. Each of the switches 230, 232 are used to provide feedback from the user to the processor, such as inputting number of players, inputting answers to questions, designating the start or end of a timed period, notification of readiness to answer a question, etc. The main pressure switch 230 is typically used for providing types of feedback that is either timed or frequent since the larger size of the switch 230 allows it to be most easily pressed. The smaller secondary pressure switches 232 may be used for providing specific types of feedback that are less frequently or urgently requested. However, it may be appreciated that any number of switches may be present in any arrangement and of any size to provide any type of feedback. In addition, one or more lights 234, such as an LED, may be present on or within the switch 260. Such lights 234 may be illuminated upon pressing an associated pressure switch to indicate that the switch has be successfully pressed. FIG. 12B provides a right side view of the user activated switch 206 of FIG. 12A. Similarly, FIG. 12C provides an end view of the user activated switch 206 of FIG. 12A. As shown, the switch 206 is domed having a height of approximately 0.81 inches.

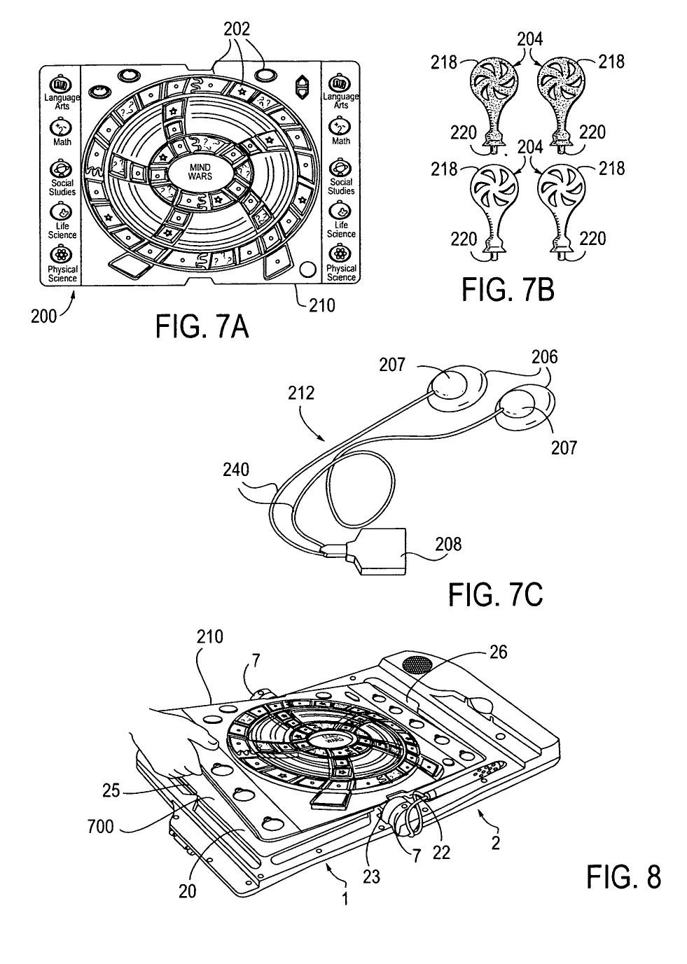

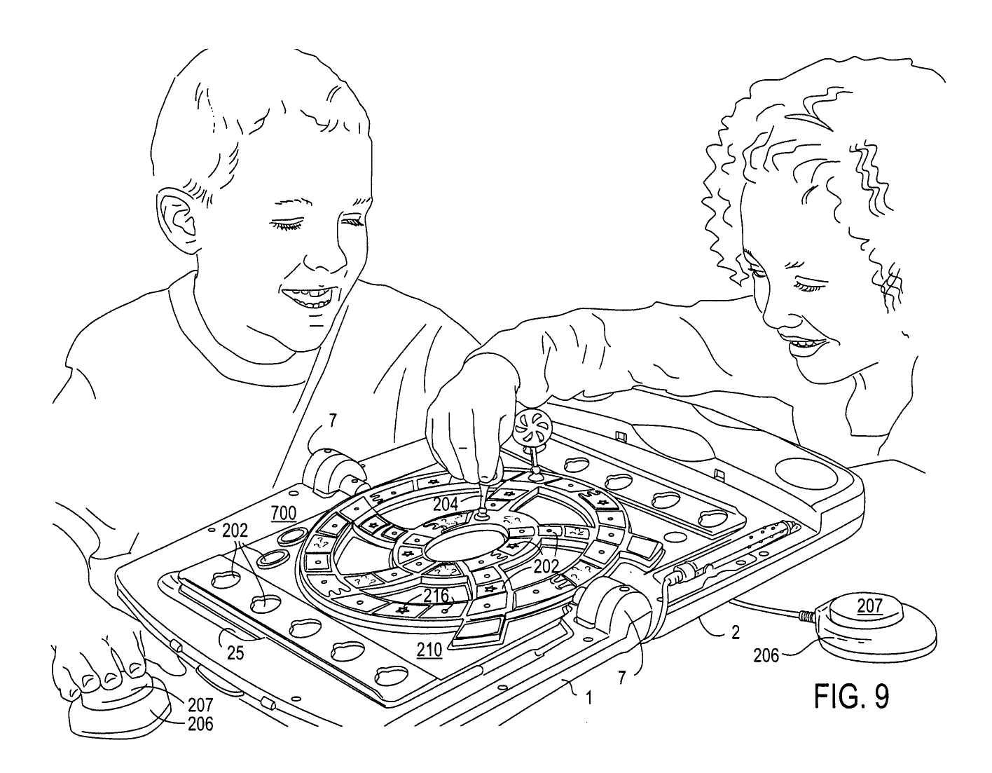

FIG. 13 illustrates an embodiment of a memory cartridge 208 of the present invention. The user activated switches 206 are electronically coupled to the memory cartridge 208 by a tether 240. A mechanical linkage 242 is also shown which may be used to structurally couple the switches 206 to the cartridge 208. This may be done so that the switches 206 and the cartridge 208 may be compactly stored together when they are not in use. It may be appreciated that any number of switches 206 may be electronically and mechanically coupleable to the cartridge 208. FIGS. 14A-14B illustrate two switches 206 electronically and mechanically coupled to a cartridge 208. Here, the switches 206 are electronically coupled to the cartridge 208 by tethers 240 and structurally coupled to the cartridge 208 by mechanical linkages 242, one switch 206 structurally coupled to each side of the cartridge 208 as illustrated in FIG. 14B.

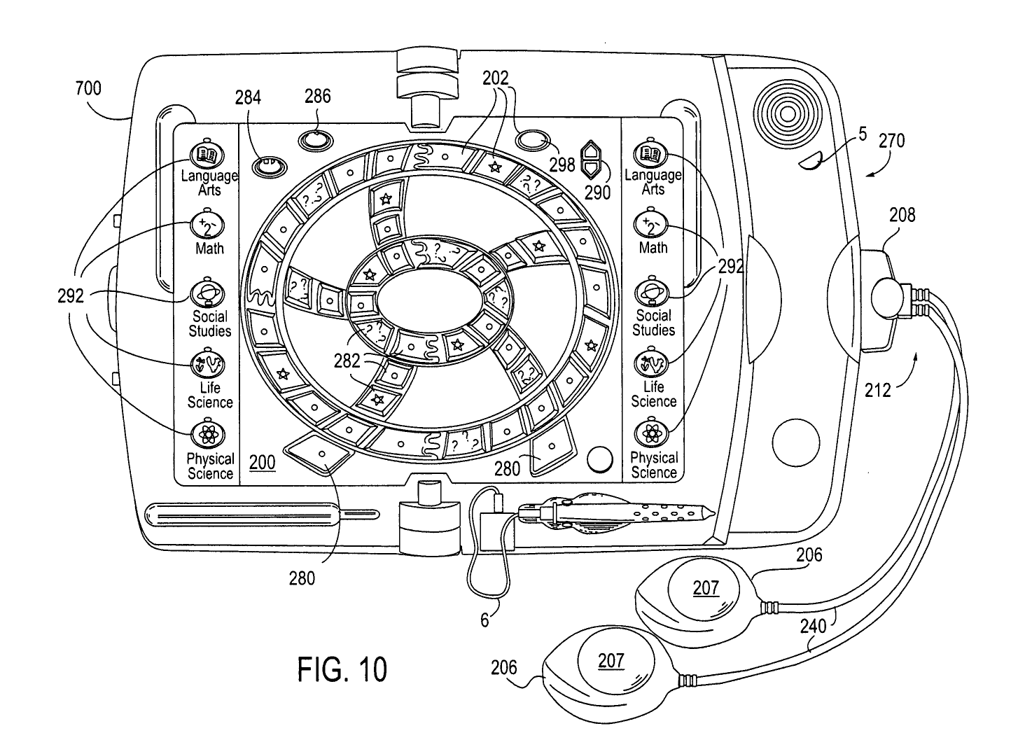

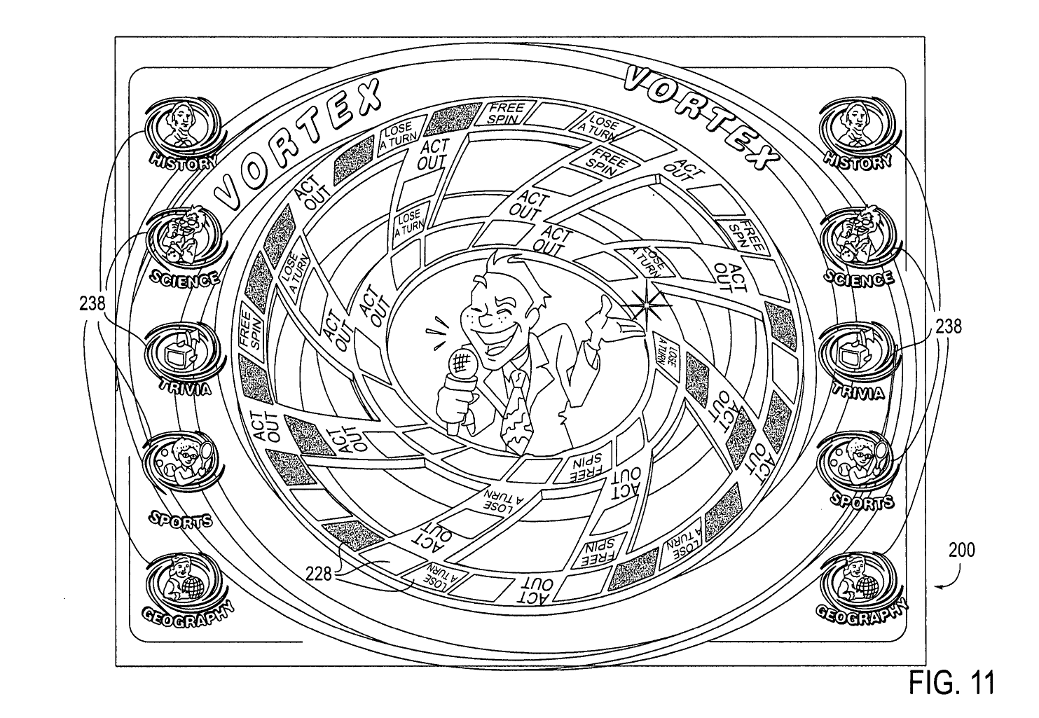

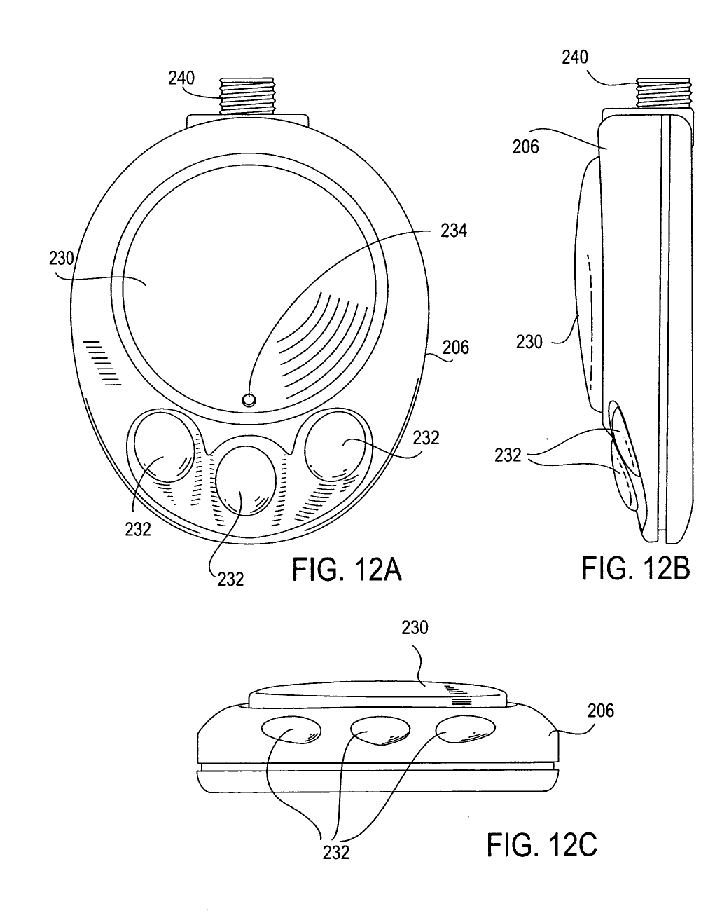

FIGS. 15A-15D provide another embodiment of a memory cartridge 208 of the present invention. Here, the cartridge 208 has a substantially rectangular shape with a width of approximately 2.31 inches, a height of approximately 3.26 inches, and a thickness of approximately 0.51 inches. FIG. 15B provides a right side view of the memory cartridge 208 of FIG. 15A. Similarly, FIG. 15C provides an end view of the memory cartridge 208 of FIG. 15A. FIG. 15D provides an exploded view of the memory cartridge 208 revealing an electronic component such as a circuit board 250 sandwiched between a top cover 252 and a bottom cover 254. In addition, connectors 256 are shown that facilitate coupling of the cartridge 208 to the user activated switches 206 by tethers 240, as illustrated in FIG. 16A. A mechanical linkage 242 is also shown which may be used to structurally couple the switches 206 to the cartridge 208. In this embodiment, the linkage 242 comprises a post 258 that extends outwardly from the cartridge 208. Each switch 206 includes a recess 260 that is mateable with the post 258, such as snaps together. Thus, the switches 206 may be structurally coupled to the memory cartridge 208, as illustrated in FIG. 16B.

Game Play

Referring back to FIG. 10, a game apparatus 270 of the present invention is illustrated. In this embodiment the apparatus 270 includes a platform 700 having a surface, an array of electrical elements under the surface, a processor unit coupled to the array of electrical elements, and a memory device coupled to the processor. The apparatus 270 also includes two user activated switches 206 coupled to the platform 700, each user activated switch 206 capable of being in electrical communication with the processor. And, the apparatus 270 includes a print medium 200 including print elements 202 corresponding to a game, wherein the print medium 200 is capable of being received on the surface.

The game provided by the print elements 202 may have a variety of forms. In the embodiment illustrated in FIG. 10, the print elements 202 include two start blocks 280, a variety of marker spaces 282 and a variety of subject categories 292. In one embodiment, the game begins with the markers 204 positioned at the start blocks 280. Upon pressing an ON/OFF button 5 to turn the apparatus ON, the user is prompted by an audio output to select one of three modes of play: 1) Single Player Mode, 2) Two Player Mode or 3) Team Mode. The user selects the mode by activating one of the user activated switches 206. In the Single Player Mode, the sequence of the game is designed for one person and only one user activated switch 206 is used. For example, in the Single Player Mode an object of the game may be to complete the game in as few moves of the marker 204 as possible. The apparatus 270 may keep track of the number of moves it takes for the player to fulfill all of the subject categories 292. This number may be stored and compared to the number of moves that were required in previous sessions. In the Two Player Mode, the sequence of the game is designed for two players and two user activated switches 206 are used, one designated for each player. The Team Mode functions similarly to the Two Player Mode wherein there are two teams of players rather than two players. Again, two user activated switches 206 are used, one designated for each team. Thus, a plurality of players may interact with the apparatus 270 at the same time.

The first player (such as the blue player) then activates their user activated switch 206 to receive an auditory output stating the number of marker spaces 282 to move along the game board. Thus, the user activated switch serves as virtual dice or a virtual spinner. The blue player then moves their associated (blue) marker 204 the designated number of spaces 282 along a path and positions the protruding tip 220 of the marker 204 into an indentation 216 in the designated space 282. To register the position of the marker 204 with the apparatus 270, the user is instructed to touch the designated space 282 with the stylus 3. As described above, the electromagnetic fields in the platform 700 induce voltage potentials in the brass ferule 108 of stylus 3. This signal is then passed via the wire 6 to the receiver unit 122. The receiver unit 122 then processes the induced voltage and a processed signal is then passed to the controller unit 120. The controller unit 120 then converts the processed signals received from the receiver unit 122 into signals identifying the coordinates of the marker space 282 at which the stylus 3 is currently located. These coordinates are then used to select an appropriate sound stored within a sound memory either provided as a memory chip within the memory cartridge 208. The appropriate sound is then output an audio output.

If the marker 204 is not correctly positioned, i.e. in inappropriate marker space 282 has been touched such as by miscounting, the audio output may include a message such as “Keep going” or “You've gone too far”. This indicates to the user that the marker 204 is misplaced and correction is desired. Thus, the apparatus 270 is able to keep track of the positions of the markers 204 and all of the possible next positions based on the number of spaces indicated to move the marker. Once the marker 204 has been correctly positioned and registered, the user then hears an audio output related to the marker space 282 that was landed upon.

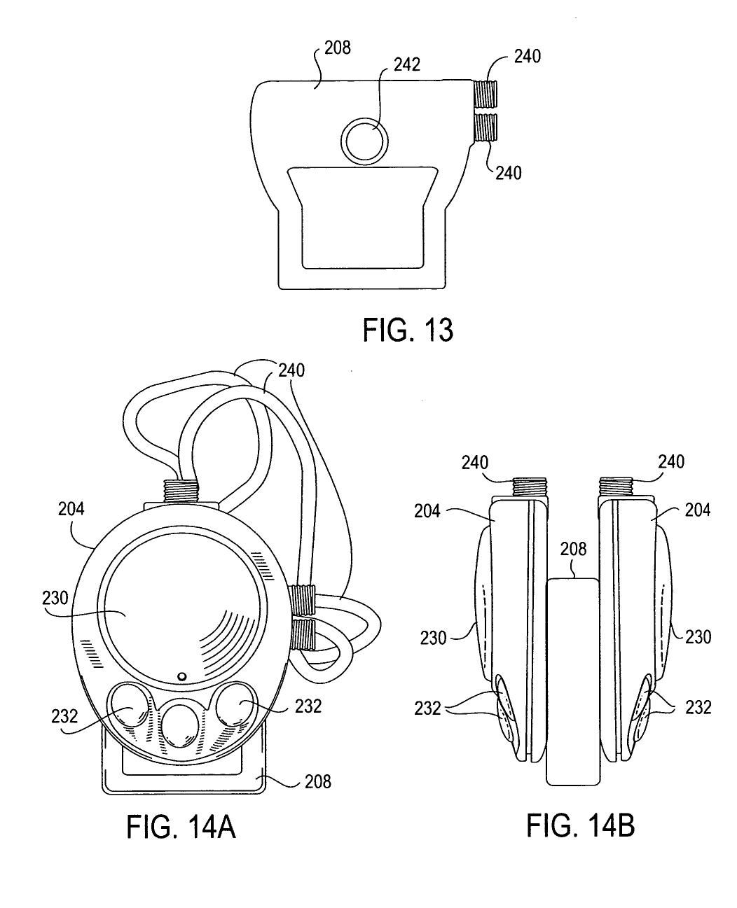

A variety of different types of marker spaces 282 are provided, including five different types of Subject spaces 294 corresponding to subject categories 292, Act Out spaces 296 and Chance spaces 298, to name a few. FIG. 17 illustrates examples of Subject spaces 294 and corresponding subject categories 292. Typically, the Subject spaces 294 are color coded to correspond to the subject categories 292. In this example, the subject categories 292 include language arts 300, math 302, social studies 304, life sciences 306, and physical science 308.

When the marker 204 is registered as positioned on a Subject space 294, the user hears a question related to the corresponding subject category 292. In one embodiment, the question is one of four different types of questions: 1) a multiple choice question, 2) a true or false question, 3) a head-to-head question, and 4) double or nothing. Typically, multiple choice questions offer three possible answers, however any number of possible answers may be offered. For example, if the user has landed on a Subject space 294 corresponding to social studies 304, the user may hear a question such as “Which country is south of the United States? A) Mexico, B) Baja or C) Canada?”. The user responds by activating the user activated switch 206 once to select answer (A), twice to select answer (B), and three times to select answer (C). If the user selects an incorrect answer such as answer (B), the user may hear an auditory output such as “Nope. Baja is a state in the country of Mexico. Good try.” The user or another player is then prompted to activate a user activated switch 206 to hear an auditory output stating the number of marker spaces 282 to move along the game board.

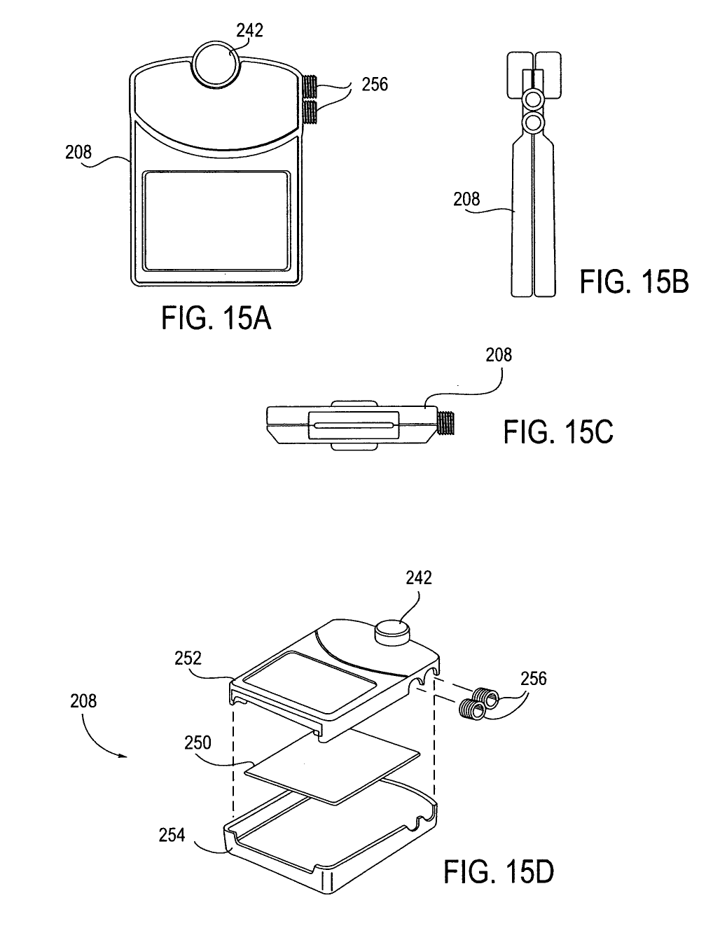

If the user selects the correct answer, the user may hear a congratulatory phrase and instructions to close a window corresponding to the social studies subject category 292. Each of the subject categories 292 are depicted as in FIG. 10 along the outer margins of the board 210. Each subject category 292 has an associated window 316, as illustrated in FIGS. 18A-18B. The window 316 may be comprised of a sheet having a handle, such as an upper protrusion 318 and lower protrusion 320, disposed thereon so that the window 316 may be opened and closed by pulling or pushing against the handle. FIG. 18A illustrates a window 316 in the open position. In some embodiments, all of the windows 316 begin in the open position at the start of the game. In this embodiment, one object of the game is to be the first player or team to close all of their windows 316, one window 316 for each subject category 292. Thus, the windows 316 provide a visual indication of which subject categories 292 or fulfilled.

When the user answers a question correctly, the user hears instructions to close the window 316 corresponding to the subject category 292 as stated above. The user pushes downward against the lower protrusion 320 with the stylus 3 to close the window 316, as illustrated in FIG. 18B. As described above, the electromagnetic fields in the platform 700 induce voltage potentials in the brass ferule 108 of stylus 3. This signal is then passed via the wire 6 to the receiver unit 122. The receiver unit 122 then processes the induced voltage and a processed signal is then passed to the controller unit 120. The controller unit 120 then converts the processed signals received from the receiver unit 122 into signals identifying the subject category 292 that has been closed. Thus, the apparatus 270 is able to electronically keep track of which windows have been closed and which windows remain open.

It may be appreciated that the windows 316 may be comprised of any suitable material, including rigid or flexible plastics, paper, or cardboard, to name a few. Likewise, the windows 316 may be transparent, partially transparent or opaque. The handles used to move the windows 316 may be formed into the windows 316, such as the protrusions 318, 320, or may be attached to the windows 316. Further, it may be appreciated that the windows 316 may open and close by mechanisms other than sliding. For example, the window may rotate or may be moved angularly in relation to the board 210 (such as by pulling a flap that opens and closes like a trap door). Still further, other mechanism may be used to indicate that a subject category 292 has been successfully fulfilled. In addition, it may be appreciated that the windows 316 may begin in the closed state wherein each window 316 is opened when a subject category has been successfully fulfilled.

In some situations when the marker 204 is registered as positioned on a Subject space 294, the user receives a true or false question related to the corresponding subject category 292. For example, if the user has landed on a Subject space 294 corresponding to math 302, the user may hear a question such as “True or false, six times three equals twenty four?”. The user responds by activating the user activated switch 206 once to select True and twice to select False. If the user selects an incorrect answer such as True, the user may hear an auditory output such as “Sorry, six times three equals eighteen. Good try.” The user or another player is then prompted to activate a user activated switch 206 to hear an auditory output stating the number of marker spaces 282 to move along the game board. If the user selects the correct answer, the user may hear a congratulatory phrase and instructions to close a window corresponding to the math subject category 292.

In other situations when the marker 204 is registered as positioned on a Subject space 294, the user receives a head-to-head question related to the corresponding subject category 292. In head-to-head questions, a question is heard and both players or both teams of players compete to answer the question. The question may be a multiple choice question or a true or false question, as described above. As the question is heard, the players may interrupt the question by activating their user activated switch 206 or the players may wait until the entire question is heard. The first player or team to activate their user activated switch 206 gets to answer the question. If the question is answered incorrectly, the user or another player is then prompted to activate a user activated switch 206 to hear an auditory output stating the number of marker spaces 282 to move along the game board. If the user selects the correct answer, the user may hear a congratulatory phrase and instructions to close a window corresponding to the subject category 292.

In still other situations when the marker 204 is registered as positioned on a Subject space 294, the user receives a double or nothing question related to the corresponding subject category 292. Double or nothing questions are heard when the user has landed on a Subject space 294 corresponding to a subject category 292 which has already been fulfilled (i.e. whose window 316 has already been closed). The double or nothing question may be of any form mentioned above. However, if the user answers the question correctly, the user is instructed choose any other subject category 292 for fulfillment (i.e. close any other open window with the stylus 3). If the user answers the question incorrectly, the user loses fulfillment of the subject category 292 (i.e. open the window with the stylus 3). Thus, the apparatus 270 is able to keep track of which windows have been closed and which windows remain open at any given time due to the action of the stylus 3.

The questions provided by the apparatus 270 are designed to be suitable for a variety of skill levels by the players. In some embodiments, the questions are categorized by skill levels and any number of levels may be available, such as three skill levels. Since the skill level of each player may vary based on subject category, the memory device may include code for correlating skill level to each subject category for each player. In addition, the skill level may be adaptive for each player. For example, the apparatus 207 may track the level of difficulty desired for each subject category for each player, and this level of difficulty may change based on the correct or incorrect responses provided to the questions. A correct answer response with increase the level of difficulty, and, likewise, an incorrect answer response will decrease the level of difficulty. At the lowest level an incorrect answer will generally not change the difficulty level, and, likewise, a correct response at the highest level will generally not change the difficulty level. In some embodiments, during head-to-head questions, the players turn determines whether difficulty level changes. For example, if the player answering the question is the player who's turn it was at the beginning of the question, the difficulty level may be adjusted.

In some embodiments, a Buzz-Off may be employed. In a Buzz-Off, a series of questions are heard by the players. Each player answers the questions with their own user activated switch 206. The apparatus 270 keeps track of the number of correct and incorrect answers provided by each player. A winner may be determined by comparing the difference between correct and incorrect responses for the players. For example, a player with one correct answer and zero wrong answers may beat a player with two correct answers and two wrong answers. In some embodiments, negative scores are not allowed so that if one player has zero correct answers and one wrong answer and the other player has zero correct answers and two wrong answers, an audio output of “Nobody won this Buzz-Off” may be heard.

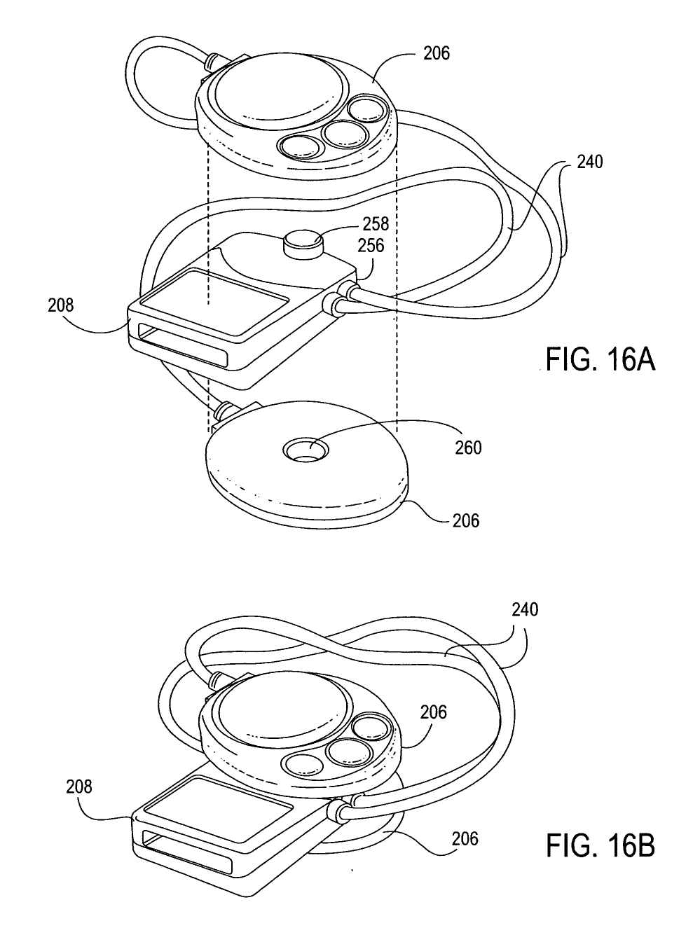

As mentioned, marker spaces 282 other than Subject spaces 294 may be provided, such as wild spaces. Examples of wild spaces include a Chance space 298 and an Act Out space 296. FIG. 19 illustrates an embodiment of a Chance space 298. When a marker 204 has been correctly positioned and registered on a Chance space 298, the user hears an audio output that instructs the user to activate the user activated switch 206 to learn his/her fate. Upon activating the user activated switch 206, the user may steal fulfillment of a subject category 292 from an opponent or have fulfillment of a subject category 292 stolen by an opponent. When stealing fulfillment, the user opens one of the opponent's windows 316 and closes a window 316 of his/her own. When fulfillment is stolen, the opponent opens one of the user's windows 316 and closes a window 316 of his/her own. Again, the apparatus 270 is able to keep track of which windows have been closed and which windows remain open at any given time due to the action of the stylus 3.

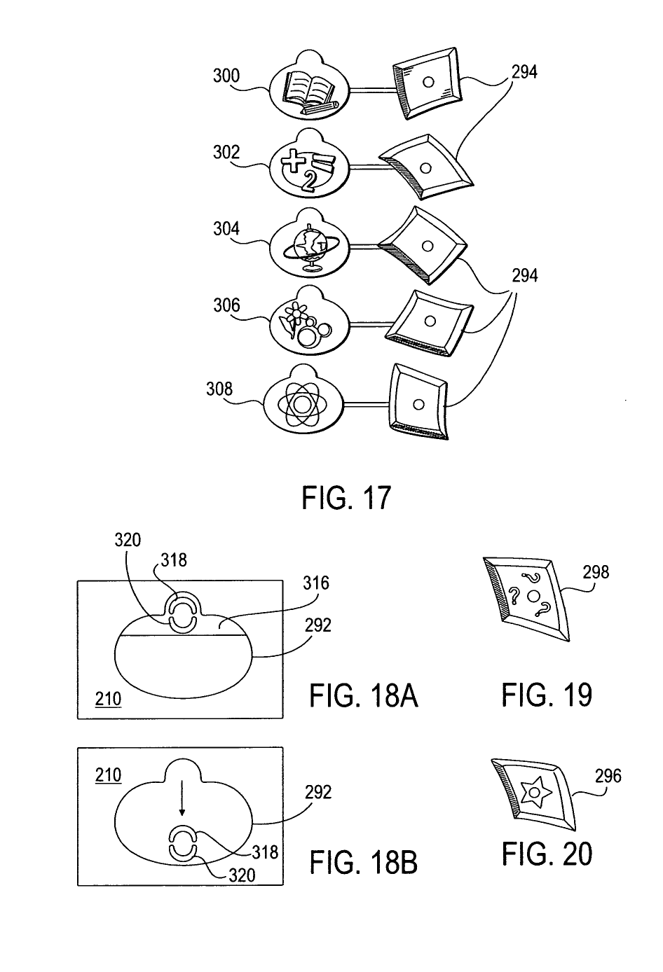

FIG. 20 illustrates an embodiment of an Act Out space 296. When a marker 204 has been correctly positioned and registered on an Act Out space 296, the user hears an audio output that instructs the user to activate the user activated switch 206 to choose a challenge. For example, the user may hear a prompt such as “If you're feeling mellow, press the buzzer once. If you're feeling silly, press the buzzer twice.” Upon activating the user activated switch 206 once, the user selects a mellow challenge and may hear instructions to perform an act that can be achieved while sitting down, such as “Sing the alphabet song.” Upon activating the user activated switch 206 twice, the user selects a silly challenge and may hear instructions to perform an act that is achieved by being active, such as “Jump around and act like a monkey.” In either case, the user performs the challenge until a user activated switch 206 is activated, such as by the opponent. The user may then receive an audio output such as applause, granting of another turn or instructions to close one of the user's windows 316 thereby fulfilling another subject category 292.

At any time during play, a board button such as a pause button 284, repeat button 286, rules button 288, and volume button 290 may be activated, such as by touching with the stylus 3. Activating the pause button 284 pauses the game until the pause button 284 is reactivated to resume playing. In some embodiments, the game is automatically resumed after a predetermined period of time, such as 10 minutes, absent reactivation. Activating the repeat button 286 repeats the auditory output, such as the last question asked. Activating the rules button 288 prior to starting the game provides instructions on how to play the game. Activating the rules button 288 while playing the game provides instructions related to the circumstances of the game at that time, such as providing instructions related to the marker space 282 landed on by the marker 204. Activating the volume button 290 increases or decreases the volume of the audio output.

The game is continues with the players moving their markers 204 along the path of marker spaces 282 in any fashion until a player or team of players is designated the winner, such as by fulfilling all of their subject categories 292 (i.e. closing all of their windows 316).

It may be appreciated that the elements of the above described game are exemplary and may include a variety of variations while remaining within the scope of the present invention. For example, other marker spaces 282 may be present which correspond to other play sequences, features or activities which may or may not include subject categories 292. When subject categories 292 are present, the categories may differ from the examples stated above. The position of the markers 204 may be registered by an element other than a stylus 3, such as by the markers 204 themselves. Further, the rules of the game may differ, the object of the game may differ and the method of play may differ, to name a few. However, each embodiment typically includes one or more of the features described herein.

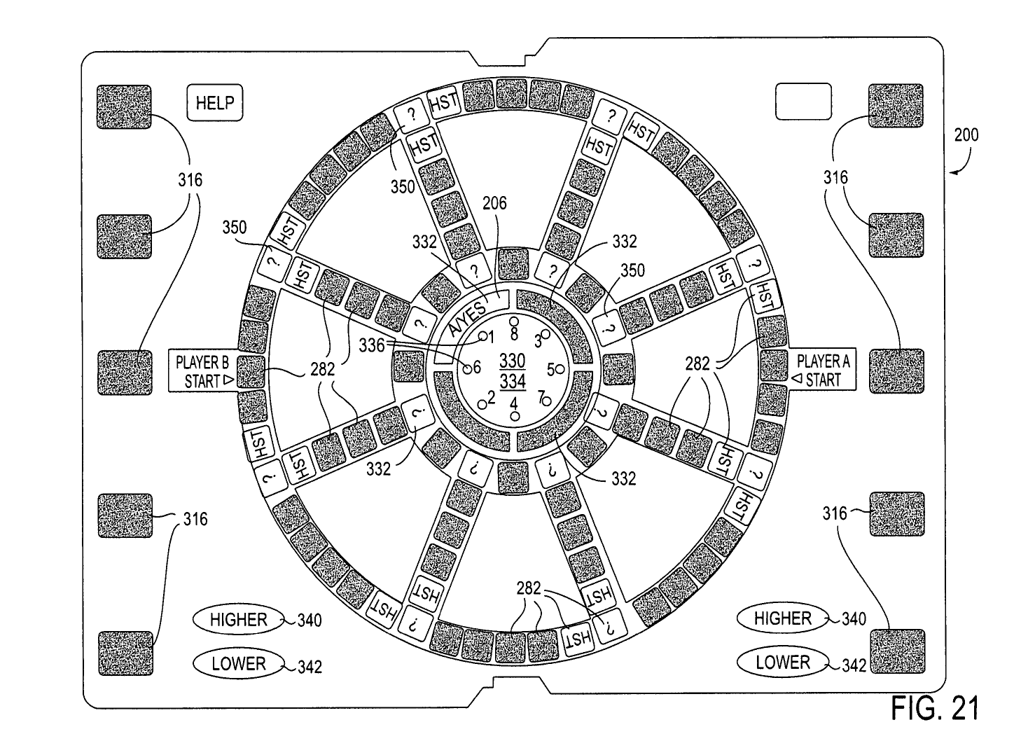

Referring to FIG. 21, another embodiment of a print medium 200 having print elements corresponding to a game is provided. In this embodiment, the user activated switches 206 are disposed on the print medium 200. The switches 206 may be tethered to a memory cartridge 208, such as to form an electrical device 212, and positioned in a designated location on the print medium 200. Or, the switches 206 may be embedded or integral with the print medium 200. In this embodiment, the user activated switches 206 include a virtual spinner 330 and a variety of answer buttons 332. The virtual spinner 330 is comprised of a dome 334 having a plurality of lights 336 around its perimeter, such as eight lights. The lights 336 may be any suitable lights, such as LEDs. A number is disposed next to each light 336 as shown; in this case numbers 1-8. When the dome 334 is pressed, the lights 336 may illuminate at random, ultimately illuminating a single light 336. The number corresponding to the illuminated light 336 represents the number of marker spaces 282 that the player is instructed to travel.

To answer a question, the user presses one of the answer buttons 332. Each answer button 332 may have a different color and may illuminate when pressed. Each answer button 332 may also be labeled, such as “A/Yes”, “B/No”, “C” and “D”. Thus, the player may press A, B, C, or D to answer a multiple choice questions. Two of the buttons 332 may be reused to answer Yes or No. It may be appreciated that the answer buttons 332 may have any suitable labels to answer different types of questions, such as True or False.

The print medium 200 may also include windows 316. In this embodiment, two sets of five windows 316 are shown. The windows 316 may be positioned on the left, right or bottom edges of the medium 200 or may be integrated into the artwork. A player may use the stylus 3 to open and close the windows 316 as described herein above.

In some embodiments, an object of the game is to gain control of playing for the windows 316. This is achieved by making the opponents answer questions and then correctly agreeing or disagreeing with the opponent's answer. Each player starts in his/her specific starting point on the print medium 200; for example, Player A starts on one side and Player B starts on the other side.

In this scenario Player A gets to start the game. Player A activates the virtual spinner 330 to determine how many spaces he can move his marker 204 (between 1 to 8 spaces). Player A spins a 5 thus he can move five squares in any direction. Before moving the player is considering what category of question to ask his opponent, thus which direction to move. Question categories may include: Geography. Science, History, Pop Culture, Sports, and Wild (wild can be any of the others and possibly including additional subjects, such as Math and Language). Player A then moves his piece 5 spaces to the SCIENCE square. An audio output announces that Science is the category and that Player B better get ready to test her scientific method. A multiple choice question may then be heard and Player B may have a predetermined limited time, such as 20 seconds, to answer by pressing the correct A, B. C or D answer button 332. Once Player B has pressed an answer button 332 the apparatus 270 asks Player A to either agree or disagree with Player B by pressing the YES or the NO answer button 332. Player A may have a predetermined designated period of time, such as 15 seconds, to press YES or NO. If Player A does not press YES or NO within 15 seconds or makes an incorrect YES or NO guess then an audio output may provide the correct answer. And, if Player B has answered correctly then she gets control of the windows 316. If in this scenario Player B is incorrect then no player gets control of the windows 316 and game play goes to Player B.

If Player A does make the correct YES or NO guess within the 15 second time period, then he gets control of the windows 316. The correct answer is announced and then introduces playing the windows 316, instructing Player A to touch a space in a first open window 316. Player A touches the open space of the first open window and a number is provided by the audio output, such as any number between 2 and 7. In this example, the number 3 is provided. Using the stylus 3, Player A then secretly touches either his “HIGHER” button 340 or “LOWER” button 342 on the print medium 200. This registers whether he thinks Player B will spin higher or lower than 3. The audio output provides that the votes are in and it's time for Player B to spin. Player B activates the virtual spinner 330. If Player A has correctly guessed Higher or Lower to match the spin, then he gets to close the window 316 with his color (Blue). He then touches the closed window 316 to register his points. The apparatus 270 then announces that Player A has just a designated number of points, such as 50 points. If Player A has incorrectly guessed then no one gets the window 316 and the play moves to Player B.

When the play moves to the next player's turn, in this case Player B, that player then gets to spin and move his/her marker 204. In this embodiment, Player B spins a 3 and decides to move three squares to the “?” (Wild) square 350. When on a wild square 350 the game play differs slightly in that the two players go head-to-head answering questions. A question from any category can be asked. If a player buzzes in and incorrectly answers a question he/she loses a designated number of points, such as 50 points, and has to re-open one of his/her windows. If a player buzzes in and correctly answers a question he/she automatically gets to close a window and scores a designated number of points, such as 50 points.

Once Player B moves her piece to the wild square the apparatus 270 announces that it's a ShowTime showdown and the players have to compete head-to-head. The apparatus 270 then provides the answers to the question first, and then reads the question itself. The reason for this reverse reading is to prompt the players to try to guess the correct answer before they've heard the entire question. It is almost as if based on the answers, the players are trying to guess what the question will be. The players may hear, “Let's take a trip around the globe and see who has the fastest fingers with this tidbit about geography. The answers are: A) Africa, B) South America, C) Asia, And D) Australia. This southern continent is home to the Bengal Tiger.” Because the players are sharing the same user activated switches 206, they need to wait long enough to try to figure out the question, but they also want to beat their opponent to the switch 206. If Player A presses the switch 206 before the entire question has been read the audio will be interrupted and the player will be asked to press a button to answer the question in a designated period of time, such as 20 seconds. If he answers correctly then he gets to close a window 316 and gets a predetermined number of points, such as 50 points. If he answers incorrectly he has to open a window and loses a predetermined number of points, such as 50 points.

If Player A did answer incorrectly, then the entire question with be provided for Player B and Player B will have a designated period of time, such as 15 seconds, to answer the question. Player B can either answer the question and thus gain points, such as 50 points, if answering correctly or lose points, such as 50 points, if answering incorrectly. If Player B doesn't know the answer she can let the clock run out and not risk guessing and losing any points.

In this embodiment, game play continues until all of the windows 316 have been closed. When all of the windows 316 have been closed the apparatus 207 announces the final score and announces a ShowTime Champion.

The terms and expressions which have been employed herein are used as terms of description and not of limitation, and there is no intention in the use of such terms and expressions of excluding equivalents of the features shown and described, or portions thereof, it being recognized that various modifications are possible within the scope of the invention claimed.

Moreover, any one or more features of any embodiment of the invention may be combined with any one or more other features of any other embodiment of the invention, without departing from the scope of the invention.

All patent applications, patents, and publications mentioned above are herein incorporated by reference in their entirety for all purposes. None is admitted to be prior art.

1. A game apparatus comprising:
a platform including a surface, an array of electrical elements under the surface, and a processor unit coupled to the array of electrical elements;
a memory device coupled to the processor;
a user activated switch coupled to the platform, the user activated switch capable of being in electrical communication with the processor; and
a print medium including print elements corresponding to a game, wherein the print medium is capable of being received on the surface.

2. The game apparatus of claim 1 wherein the user activated switch comprises a pressure switch.

3. The game apparatus of claim 1, wherein the user activated switch is removably coupled with the platform.

4. The game apparatus of claim 1, wherein the memory device comprises a memory cartridge removably coupled with the platform.

5. The game as in claim 4, wherein the user activated switch is attached to the memory cartridge, and wherein coupling of the memory cartridge with the platform couples the user activated switch with the platform.

6. The game apparatus of claim 1 wherein the user activated switch is a first user activated switch and wherein the apparatus further comprises a second user activated switch.

7. The game apparatus as in claim 1, wherein the memory device includes code for an audio output corresponding to at least one of the print elements.

8. The game apparatus as in claim 1, wherein the memory device includes code for an audio output corresponding to activation of the user activated switch.

9. The game apparatus of claim 1 wherein the electrical elements comprise transmitting antenna elements.

10. A gaming system comprising:
a platform including a surface, an array of electrical elements under the surface, and a processor unit coupled to the array of electrical elements;
a memory device coupled to the processor;
a print medium including print elements corresponding to a game having marker spaces, wherein the print medium is capable of being received on the surface; and
a marker positionable on the print medium and moveable along the marker spaces.

11. A gaming system as in claim 10, wherein the memory device includes code for identifying the position of the marker on the marker spaces.

12. A gaming system as in claim 10, wherein the marker spaces include at least one subject space correlated to a subject category.

13. A gaming system as in claim 12, wherein the subject category is selected from the group consisting of language arts, math, social studies, life sciences and physical science.

14. A gaming system as in claim 10, wherein the memory device includes code for providing a question related to at least one of the marker spaces.

15. A gaming system as in claim 14, wherein the question comprises a multiple choice question.

16. A gaming system as claim 14, wherein the at least one of the marker spaces is correlated to a subject category and the question is related to the subject category.

17. A gaming system as in claim 10, further comprising a stylus connected with the processor, wherein the stylus transmits a signal indicating a position on the print medium.

18. A gaming system as in claim 10, further comprising a user activated switch coupled to the platform, the user activated switch capable of being in electrical communication with the processor.

19. A game apparatus comprising:
a platform including a surface, an array of electrical elements under the surface, a processor unit coupled to the array of electrical elements, and a memory device coupled to the processor, wherein the memory device comprises code for a game including at least two players; and
a print medium including print elements corresponding to the game, wherein the print medium is capable of being received on the surface.

20. A method of using a game apparatus comprising:
providing the game apparatus, wherein the game apparatus comprises
a platform including a surface, an array of electrical elements under the surface, and a processor unit coupled to the array of electrical elements,
a memory device coupled to the processor,
a print medium including print elements corresponding to a game, wherein the print medium is capable of being received on the surface;
registering the position of a marker on the print medium; and
receiving an auditory output related to the position of the marker.

21. A method as in claim 20, wherein the game apparatus includes a stylus connected with the processor, and wherein registering the position of the marker comprises transmitting a signal to the processor with the use of the stylus indicating the position of the marker on the print medium.

22. A method as in claim 20, wherein receiving an auditory output comprises receiving a question.

23. A method as in claim 22, wherein the question comprises a multiple choice question, a true-or-false question, a head-to-head question, or a double-or-nothing question.

24. A method as in claim 22, wherein the game apparatus further comprises a user activated switch coupled to the platform, the user activated switch capable of being in electrical communication with the processor, the method further comprising activating the user activated switch to answer the question.

25. An electrical device comprising:
a memory device; and
at least one input device coupled to the memory device, wherein the at least one input device is hand or finger operable and is adapted to provide user input to an apparatus to which the memory device is connectable.

26. An electrical device as in claim 25, wherein the at least one input device includes a pressure switch.

27. An electrical device as in claim 25, wherein the at least one input device includes a pressure switch, and wherein the at least one input device is coupleable to the memory device with wires.

28. An electrical device as in claim 25, wherein the memory device comprises a data cartridge.

29. An electrical device as in claim 25, wherein the memory device comprises computer code for playing a game using the at least one input device.
